(19) United States
(12) Patent Application Publication
(10) Pub. No.: US 2025/0191122 A1
(43) Pub. Date: Jun. 12, 2025

(54) IMAGE GENERATION METHOD FOR ELIMINATING SPLICING SEAMS, COMPUTER DEVICE AND STORAGE MEDIUM

(71) Applicants: Ren Ning XIAO, Shenzhen (CN); Liangqu Long, Shenzhen (CN)

(72) Inventors: Ren Ning XIAO, Shenzhen (CN); Liangqu Long, Shenzhen (CN)

(21) Appl. No.: 18/972,353

(22) Filed: Dec. 6, 2024

(30) Foreign Application Priority Data
Dec. 8, 2023 (CN) 202311689039.4

(51) Int. Cl. G06T 3/4038

(52) U.S. Cl. CPC G06T 3/4038; G06T 2207/20221

(57) ABSTRACT

Embodiments of the present application disclose an image generation method for eliminating a splicing seam. The method may include inputting input information into an AIGC image generation model; and obtaining a panoramic expansion view generated by the AIGC image generation model based on the input information, wherein a padding method of a convolutional layer in the AIGC image generation model comprises circular padding.

### CROSS REFERENCE TO RELATED APPLICATION

The present application claims priority to Chinese Patent Application No. 202311689039.4, filed Dec. 8, 2023, the entire contents of both being incorporated herein by reference in its entirety.

### TECHNICAL OF FIELD

The present application relates to the technical field of image processing, and in particular to an image generation method for eliminating splicing seams, a computer device and a storage medium.

### BACKGROUND

By shooting the surrounding environment information with a unit sphere centered on the camera, a 360-degree panoramic image can be obtained, and then the sphere can be expanded according to the longitude and latitude to obtain a 2:1 2D panoramic expansion view. Through a panoramic browsing software, the panoramic expansion view can be stitched and restored to a 360-degree panoramic image of a sphere, and users can see plane views from different angles through the software. AIGC image generation is a technology for image generation based on AIGC-related models. Images can be generated by taking text information or image information as input. AIGC image generation with image information as input can transform the content and style of the original image.

### SUMMARY

Based on this, it is necessary to provide an image generation method, a computer device and a non-transitory computer-readable storage medium that can eliminate splicing seams when splicing a 360° panoramic image to address above or other technical problems, thereby improving image quality and the user's viewing experience.

In one embodiment, the present application provides an image generation method for eliminating splicing seams. The image generation method may include inputting input information into an AIGC image generation model; and obtaining a panoramic expansion view generated by the AIGC image generation model based on the input information, wherein a padding method of a convolutional layer in the AIGC image generation model comprises circular padding.

In another embodiment, the present application further provides a computer device, comprising at least one memory and at least one processor. The at least one memory stores a computer program, and the at least one processor, when executing the computer program, is configured to input input information into an AIGC image generation model; and obtain a panoramic expansion view generated by the AIGC image generation model based on the input information, wherein a padding method of a convolutional layer in the AIGC image generation model comprises circular padding.

In another embodiment, the present application further provides a non-transitory computer-readable storage medium having a computer program stored thereon which, when executed by at least one processor, causes the at least one processor to perform steps of inputting input information into an AIGC image generation model; and obtaining a panoramic expansion view generated by the AIGC image generation model based on the input information, wherein a padding method of a convolutional layer in the AIGC image generation model comprises circular padding.

The above-mentioned image generation method, computer device and storage medium for eliminating splicing seams can obtain the generated image output by the AIGC image generation model based on the input information. The padding method of the convolution layer in the AIGC image generation model comprises cyclic padding. After the inventor found that the panoramic expansion image generated by the existing AIGC image generation model has a problem of seams when it is spliced into a 360° panoramic image, after extensive research, it was discovered that this problem can be solved by changing the padding method of the convolution layer. Without being held to a particular theory, the cyclic padding method may pad the first edge with a content of the second edge, and then pad the second edge with a content of the first edge. After padding, the contents of the first edge and the second edge are continuous, wherein the first edge and the second edge are opposite to each other. As such, the generated image can eliminate vertical seams, improve the image quality, and improve the user's perception.

### BRIEF DESCRIPTION OF THE DRAWINGS

In order to more clearly illustrate the technical solutions in the embodiments of the present disclosure, the accompanying drawings to be used in the embodiments will be briefly introduced below, and it will be obvious that the accompanying drawings in the following description are only some of the embodiments of the present disclosure, and that for the person of ordinary skill in the field, other accompanying drawings can be obtained based on these drawings, without giving creative labor.

FIG. 1A is a schematic diagram of clustered splicing seams in the Arctic and Antarctic regions of a panoramic expansion view;

FIG. 1B is a schematic diagram of a vertical splicing seam in a panoramic expansion view;

FIG. 2 is a schematic diagram showing a padding mode in a horizontal direction being changed from constant to circular in one embodiment of the present disclosure;

FIG. 3A is a schematic diagram of a first flow chart of an image generation method for eliminating a splicing seam in one embodiment of the present disclosure;

FIG. 3B is a second flow chart of an image generation method for eliminating a splicing seam in one embodiment of the present disclosure;

FIG. 4 is a schematic diagram of an initial mask in one embodiment of the present disclosure;

FIG. 5 is a schematic diagram of obtaining a target mask by blurring an initial mask in one embodiment of the present disclosure;

FIG. 6 is a third flow chart of an image generation method for eliminating a splicing seam in one embodiment of the present disclosure;

FIG. 7 is a diagram showing an internal structure of a computer device in one embodiment of the present disclosure.

### DETAILED DESCRIPTION

In order to make the purpose, technical solution and advantages of the present application more clearly understood, some embodiments of the present application are further described in detail below in conjunction with accompanying drawings and embodiments. It should be understood that the specific embodiments described herein are only used to explain the present application and are not used to limit the present application.

Currently, a 360° panoramic image can be obtained by shooting surrounding environment information through a unit sphere centered on a camera. After the sphere is expanded according to longitude and latitude, a 2D panoramic expansion view with a length to height ratio of 2:1 can be obtained. Through a panoramic browsing software, the panoramic expansion view can be spliced and restored to a 360° panoramic image of a sphere. AIGC image generation is a technology for image generation based on AIGC-related models. Images can be generated by taking text information (text to image) or image information (image to image) as input. AIGC image generation with image information as input can transform a content and a style of the original image.

However, the current AIGC image generation technology reshapes the content of the 2D panoramic expansion view, that is, the view obtained by expanding the 360° panoramic image of the sphere according to the longitude and latitude, when processing the 2D panoramic expansion view. There are splicing seams when splicing and restoring the 360° panoramic expansion view, which greatly affects the user's viewing experience.

Among them, AIGC image generation reshapes the content of the 2D panoramic expansion view, thereby destroying its original image information that closely corresponds to the longitude and latitude of the sphere, resulting in the 360° panoramic expansion view obtained by splicing and restoration having obvious vertical splicing seams in the horizontal direction and clustered splicing seams in the Antarctic and Arctic regions. The image quality is poor, thereby affecting the user's viewing experience.

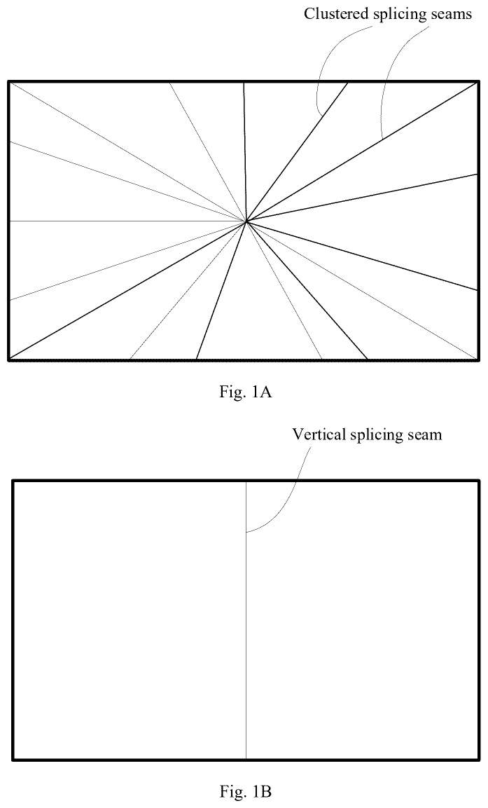

For the panoramic expansion view generated by the AIGC image generation model, FIG. 1A is a schematic diagram of clustered splicing seams in the Antarctic and Arctic regions of a panoramic expansion view. As shown in FIG. 1A, there are obvious clustered splicing seams around the center of the Antarctic and Arctic of the view.

FIG. 1B is a schematic diagram of a vertical splicing seam in a panoramic expansion view generated by a AIGC image generation model. As shown in FIG. 1B, the view has an obvious vertical seam in the horizontal direction.

An image generation method for eliminating splicing seams provided in an embodiment of the present application can be applied to a computer device or an image generation device. The image generation device can be a functional module or functional entity in the computer device, and the computer device can be a terminal or a server. Among them, the terminal can be, but is not limited to, various cameras, personal computers, laptops, smart phones, tablet computers, internet of Things devices and portable wearable devices. The internet of things devices can be smart TVs, smart car-mounted devices, etc. Portable wearable devices can be smart watches, head-mounted devices, etc. The server can be implemented as an independent server or a server cluster consisting of multiple servers.

An image generation method for eliminating splicing seams provided in an embodiment of the present application can include obtaining a panoramic expansion view generated by an AIGC image generation model based on input information. Among them, a padding method of a convolutional layer in the AIGC image generation model is circular padding. The input information can be image information, text information, or voice information, etc.

The circular padding method is to pad the first edge with the content of the second edge, and then pad the second edge with the content of the first edge. After padding, the contents of the first edge and the second edge are continuous, wherein the first edge and the second edge are opposite. By adjusting the padding method of all convolutional layers in the AIGC image generation model, the vertical splicing seams in the horizontal direction of the generated panoramic expansion view can be completely eliminated at the source.

The above-mentioned image generation method for eliminating splicing seams, by setting the padding modes of the convolution layers in the AIGC image generation model to be circular padding. The circular padding method is to pad the left edge with the content of the right edge, and then pad the right edge with the content of the left edge, so that the contents of the left and right edges are continuous, This makes an action object of the convolution layer in the AIGC image generation model change from a flat 2D image to a cylindrical image by splicing together left and right sides of the flat 2D image, so that the generated image can eliminate the vertical splicing seams in the horizontal direction when splicing into a 360 panoramic image, thereby improving the image quality.

In some embodiments, the input information is an initial panoramic expansion view, the generated panoramic expansion view is a target panoramic expansion view, and the AIGC image generation model is used to transform a content and/or style of the initial panoramic expansion view to obtain a target panoramic expansion view.

The obtaining the generated image output by the AIGC image generation model based on the input information may include, but is not limited to: inputting the initial panoramic expansion view into the AIGC image generation model so that the AIGC image generation model transforms the content and/or style of the initial panoramic expansion view, and obtaining the target panoramic expansion view output by the AIGC image generation model.

In some embodiments, when horizontal splicing is required, the padding method of the convolution layer in the horizontal direction is circular padding. When vertical splicing is required, the padding method of the convolution layer in the vertical direction is circular padding.

In one embodiment, the padding mode of the 2D convolution layer in the AIGC image generation model in the horizontal direction is circular padding, and the padding mode of the 2D convolution layer in the vertical direction can be constant padding.

In the present AIGC image generation model, the default padding method of the 2D convolutional layer is usually constant padding.

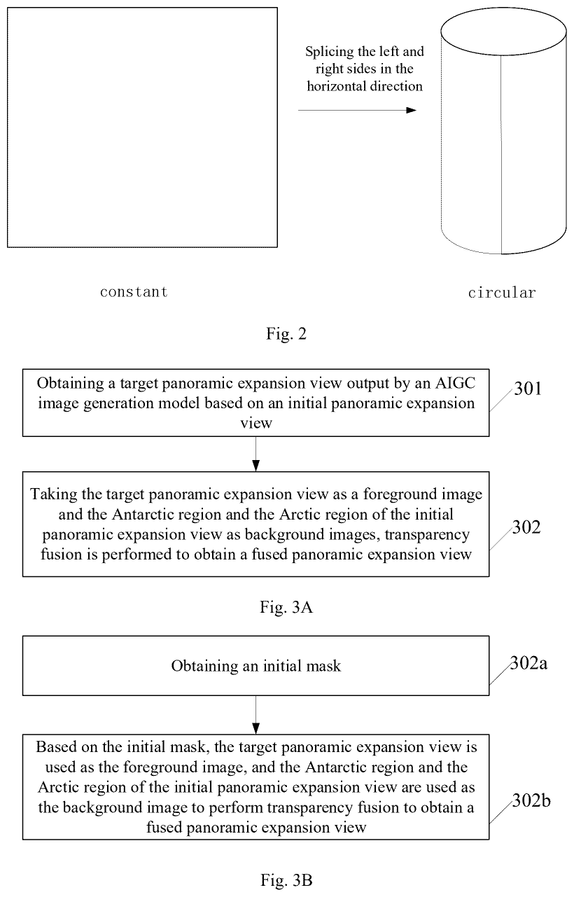

FIG. 2 is a schematic diagram of change of a padding mode of the 2D convolution layer in a horizontal direction from constant to circular in one embodiment of the present application. Among them, when the padding mode of the 2D convolution layer is constant, the action object of the 2D convolution layer is a flat 2D image. In this application, after the padding mode of the 2D convolution layer in the AIGC image generation model in the horizontal direction is changed to circular padding, the contents of the left edge and the right edge are continuous as if the action object of the 2D convolution layer is transformed into a cylindrical image by splicing together left and right sides of the flat 2D image. As such, the splicing seam in the horizontal direction is eliminated.

In one embodiment, the padding mode of the 2D convolution layer in the AIGC image generation model in the horizontal direction is set to circular, so that the left edge and the right edge of the action object of the 2D convolution layer are continuous. In this way, the generated content at the left and right of the splicing place in the target panoramic expansion view processed by the AIGC image generation model can remain consistent, eliminating the vertical splicing seams shown in FIG. 1B.

In this application, after the horizontal padding mode of the 2D convolution layer in the AIGC image generation model is changed to circular, the left and right edges of the action object of the 2D convolution layer are continuous. In this way, the generated content at the left and right of the splicing place in the target panoramic expansion view processed by the AIGC image generation model can remain consistent, eliminating vertical splicing seams and improving the user's viewing experience.

In order to improve the image quality obtained by the AIGC image generation technology and eliminate the splicing seams in the 360° panoramic expansion view restored by the AIGC image generation technology, the generated panoramic expansion view can be transparently fused (i.e., alpha fusion) with the Antarctic region and the Arctic region of the original image, thereby optimizing the clustered splicing seams of the Antarctic region and the Arctic region.

In some embodiments, a fused panoramic expansion view may be obtained by fusion of a target area based on the initial panoramic expansion view and the target panoramic expansion view.

In some embodiments, the target region is the Antarctic region and/or the Arctic region.

The Antarctic region is an image region composed of first pixels in the view, and the first pixels are pixels whose distance from a bottom edge in a height direction of the view is within a preset distance.

The Arctic region is an image region composed of second pixels in the view, and the second pixels are pixels whose distance from a top edge in the height direction of the view is within a preset distance; wherein the preset distance is a preset multiple of the height of the view, and the preset multiple is less than ½.

Exemplarily, the preset multiple may be 1/10. It should be noted that the preset multiple may be set according to actual needs in practical applications, and the values disclosed in the embodiments of the present application are only examples.

In one embodiment, as shown in FIG. 3A, a flow chart of an image generation method for eliminating splicing seams is provided, the method comprising following steps 301 and 302:

301: obtaining a target panoramic expansion view output by an AIGC image generation model based on an initial panoramic expansion view.

The initial panoramic expansion view is the input of the AIGC image generation model, or the initial panoramic expansion view is an image obtained by the AIGC image generation model based on an image description text.

For the case where the initial panoramic expansion view is the input of the AIGC image generation model, the AIGC image generation model is an image-to-image AIGC image generation model. By inputting the initial panoramic expansion view into the AIGC image generation model, the target panoramic expansion view output by the AIGC image generation model can be obtained.

For the case where the initial panoramic expansion view is an image obtained by the AIGC image generation model based on the image description text, the AIGC image generation model is an AIGC image generation model that converts text to image. The image description text is input into the AIGC image generation model, and the AIGC image generation model first generates an initial panoramic expansion view based on the image description text, and then outputs a target panoramic expansion view based on the initial panoramic expansion view.

302: taking the target panoramic expansion view as a foreground image and the Antarctic region and the Arctic region of the initial panoramic expansion view as background images, transparency fusion is performed to obtain a fused panoramic expansion view.

The Antarctic and Arctic regions in the target panoramic expansion view have clustered splicing seams as shown in FIG. 1. The Antarctic and Arctic regions in the initial panoramic expansion view do not have such splicing seams because they have not been processed by the AIGC image generation model yet. The splicing seams in the target panoramic expansion view may be eliminated by fusion.

The above-mentioned image generation method for eliminating splicing seams can include obtaining the target panoramic expansion view output by the AIGC image generation model based on the initial panoramic expansion view; and use the target panoramic expansion view as the foreground image, and the Antarctic region and the Arctic region of the initial panoramic expansion view as the background image to perform transparency fusion to obtain a fused panoramic expansion view. In the target panoramic expansion view output by the AIGC image generation model, there are clustered splicing seams in the Antarctic region and the Arctic region. The Antarctic region and the Arctic region of the initial panoramic expansion view are used as background images and transparency fusion is performed with the target panoramic expansion view, so that the image features of the Antarctic region and the Arctic region in the initial panoramic expansion view can be fused into the obtained fused panoramic expansion view, thereby eliminating the clustered splicing seams and improving image quality.

In one embodiment, a second flow chart of an image generation method for eliminating splicing seams is provided. In the process of executing the above step 302, as shown in FIG. 3B, the above step 302 is implemented by the following steps 302a and 302b:

302 a: obtaining an initial mask.

The initial mask has a size consistent with that of the target panoramic expansion view, and transparency values of the Antarctic region and the Arctic region of the initial mask are greater than or equal to a preset transparency value.

In one embodiment, the preset transparency value may be a maximum transparency value, or the preset transparency value may be set based on actual needs.

302 b: based on the initial mask, the target panoramic expansion view is used as the foreground image, and the Antarctic region and the Arctic region of the initial panoramic expansion view are used as the background image to perform transparency fusion to obtain a fused panoramic expansion view.

Based on the initial mask, the target panoramic expansion view is used as the foreground image, and the Antarctic region and the Arctic region of the initial panoramic expansion view are used as the background image to perform transparency fusion to obtain a fused panoramic expansion view. This can be achieved by the following Alpha fusion formula:

Alpha fusion formula: output=mask *foreground+ (1.0-mask) *background

In formula (1), output represents the fused panoramic expansion view, mask represents the transparency value, background represents the initial panoramic expansion view, and foreground represents the target panoramic expansion view.

Exemplarily, for pixels in the Antarctic and Arctic regions of the initial panoramic expansion view, if the mask value is set to 0, then after fusion by this formula, the Antarctic and Arctic regions of the initial panoramic expansion view will be fused into the Antarctic and Arctic regions in the fused panoramic expansion view.

In some embodiments, the fusing a target area based on the initial panoramic expansion view and the target panoramic expansion view to obtain a fused panoramic expansion view may include but is not limited to: color matching the initial panoramic expansion view and the target panoramic expansion view to obtain an intermediate panoramic expansion view, and the intermediate panoramic expansion view has a similar hue to the target panoramic expansion view; fusing the target area in the intermediate panoramic expansion view with the target panoramic expansion view to obtain a fused panoramic expansion view.

In the case where there is a significant difference in color between the target panoramic expansion view and the initial panoramic expansion view, if transparency fusion is directly performed, the color difference at the fusion point will be obvious. To solve this problem, the initial panoramic expansion view can be color matched with the target panoramic expansion view by histogram matching to obtain an intermediate panoramic expansion view with a similar hue to the target panoramic expansion view, and then the target area in the intermediate panoramic expansion view is fused with the target panoramic expansion view to obtain a fused panoramic expansion view, which can avoid the problem of obvious color difference.

In some embodiments, the fusing the target area in the intermediate panoramic expansion view with the target panoramic expansion view to obtain a fused panoramic expansion view may include but is not limited to: taking the target panoramic expansion view as a foreground image and the target area in the intermediate panoramic expansion view as a background image to perform transparency fusion to obtain the fused panoramic expansion view. Among them, “similar hue” means that shapes of histograms of the two views in the red, green, and blue channels are similar or the same, or means that cumulative histograms corresponding to the two views are similar or the same.

In the target panoramic expansion view output by the AIGC image generation model, there are clustered splicing seams in the Antarctic and the Arctic regions. The Antarctic and the Arctic regions of the intermediate panoramic expansion view are used as background images and transparently fused with the target panoramic expansion view. In this way, the image features of the Antarctic and the Arctic regions of the intermediate panoramic expansion view are fused into the obtained fused panoramic expansion view, thereby eliminating the clustered splicing seams and improving image quality.

Furthermore, since the intermediate panoramic expansion view is used for fusion in the above fusion process, and the intermediate panoramic expansion view has similar hue to the target panoramic expansion view, the obtained image can avoid the problem of obvious color difference.

In some embodiments, using the target panoramic expansion view as a foreground image and the target area in the intermediate panoramic expansion view as a background image to perform transparency fusion to obtain the fused panoramic expansion view includes: obtaining an initial mask, a size of the initial mask is consistent with the size of the target panoramic expansion view; The initial mask uses the target panoramic expansion view as the foreground image, and the target area in the intermediate panoramic expansion view as the background image for transparency fusion, and the fused panoramic expansion view is obtained by fusion.

The initial mask uses the target panoramic expansion view as the foreground image and the target area in the intermediate panoramic expansion view as the background image to perform transparency fusion to obtain the fused panoramic expansion view. This is similar to the method in the above step 302b, in which the target panoramic expansion view is used as the foreground image and the Antarctic region and the Arctic region of the initial panoramic expansion view are used as the background image to perform transparency fusion to obtain the fused panoramic expansion view based on the initial mask, and the details are not repeated here.

In some embodiments, a preset edge area of the initial mask may be blackened, the preset edge area corresponds to the area in the intermediate panoramic expansion view to be fused into the target panoramic expansion view; the blackened initial mask is blurred to obtain a target mask. Then, based on the target mask, the target panoramic expansion view is used as a foreground image, and the target area in the intermediate panoramic expansion view is used as a background image to perform transparency fusion to obtain the fused panoramic expansion view.

The area in the intermediate panoramic expansion view to be fused into the target panoramic expansion view may be the Antarctic region and/or the Arctic region.

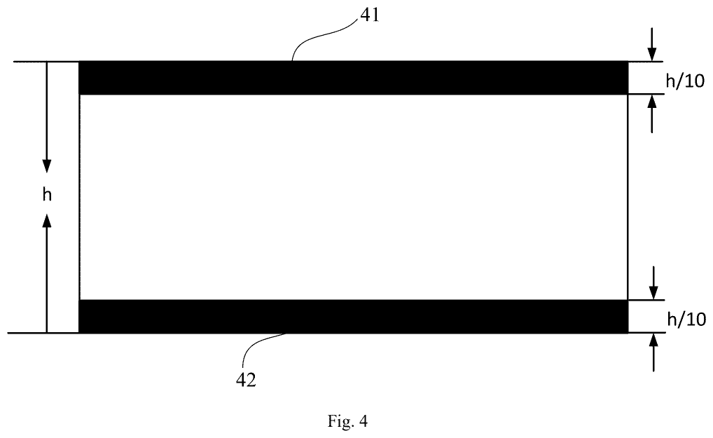

Exemplarily, the Antarctic region and the Arctic region in the initial mask can be set to black, and the Antarctic region and the Arctic region are completely transparent. FIG. 4 is a schematic diagram of an initial mask in an embodiment. As shown in FIG. 4, the Arctic region 41 and the Antarctic region 42 of the initial mask are set to black, and the Arctic region 41 and the Antarctic region 42 are completely transparent. Wherein, a height of the initial mask in FIG. 4 is h, the Arctic region 41 is an image region composed of pixels whose distance from a bottom edge in the height direction of the view is within h/10, and the Arctic region is an image region composed of pixels whose distance from the top edge in the height direction of the view is within h/10.

In the above exemplary embodiment, the initial mask is blurred to obtain a target mask with a natural transition between pixel values, and then transparency fusion is performed based on the target mask. In this way, a natural transition effect will be achieved between the fused area in the intermediate panoramic expansion view and other areas in the obtained fused panoramic expansion view, thereby further improving the image quality.

In one embodiment, the process of performing transparency fusion based on an initial mask, taking the target panoramic expansion view as the foreground image, and the Antarctic region and the Arctic region of the initial panoramic expansion view as the background image to obtain a fused panoramic expansion view may include but is not limited to: blurring the initial mask to obtain a target mask; performing transparency fusion based on the target mask, taking the target panoramic expansion view as the foreground image, and the Antarctic region and the Arctic region of the initial panoramic expansion view as the background image to obtain the fused panoramic expansion view.

The blur processing may include but is not limited to: box blur, Gaussian blur or other blur processing methods.

Optionally, taking the box blur as an example, a blur radius can be set to be greater than or equal to a preset value. Exemplarily, when the height of the mask is 1000 pixels, the preset value can be 50 pixels. It should be understood that in actual applications, the preset value can be set according to requirements. This embodiment is only an example and is not limited thereto.

For example, when the blur radius is 50 pixels, the pixel values in a 100 by 100 square area centered on a current pixel can be averaged to serve as the pixel value of the current pixel. After processing in this way, the transition between the pixel values of the entire target mask will become natural.

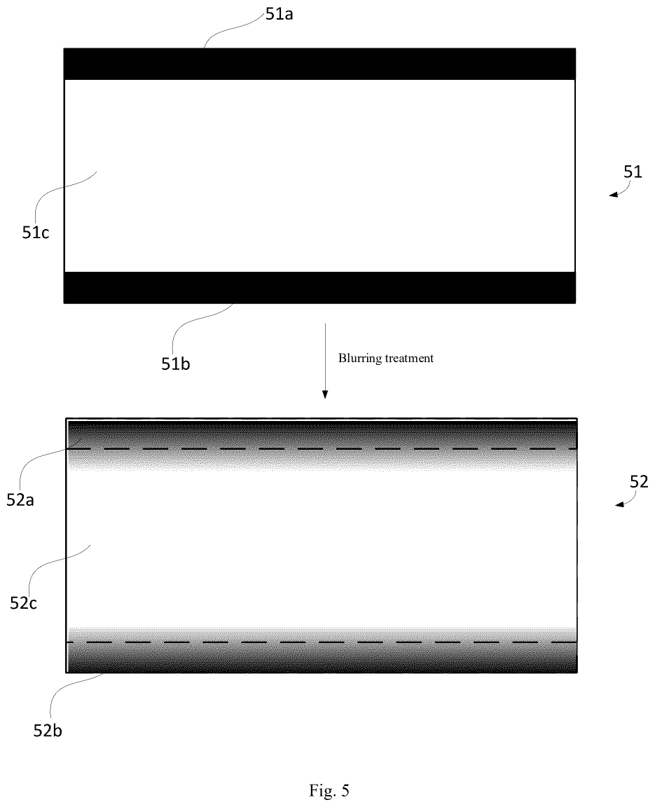

FIG. 5 is a schematic diagram of a target mask obtained by blurring an initial mask in one embodiment. A target mask 52 is obtained after blurring the initial mask 51. There is a clear boundary between the Arctic region 51a/the Antarctic region 51b in the initial mask 51 and other regions 51c in the initial mask 51, while there is no clear boundary between the Arctic region 52a/the Antarctic region 52b in the target mask 52 and other regions 52c in the target mask 52, and the transition between the pixel values of the target mask 52 becomes natural.

In the above exemplary embodiment, the initial mask is blurred to obtain a target mask with a natural transition between pixel values, and then transparency fusion is performed based on the target mask. In this way, a natural transition effect will be achieved between the Antarctic region/the Arctic region and other regions in the obtained fused panoramic expansion view, thereby further improving the image quality and enhancing the user's viewing experience.

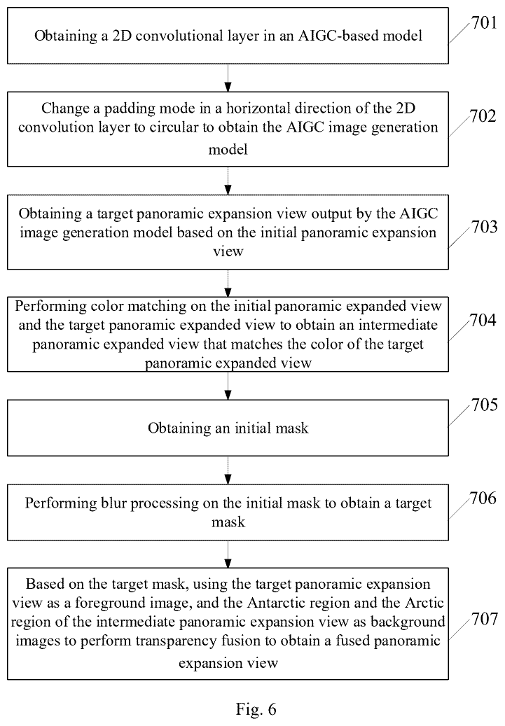

In one embodiment, as shown in FIG. 6, a flowchart diagram of an image generation method for eliminating splicing seams is provided, the method comprising steps 701 to 707:701: obtaining a 2D convolutional layer in an AIGC-based model.

In one embodiment, the AIGC-based model is an initial AIGC image generation model.

For example, the AIGC-based model may be a stable diffusion model. A Variational Auto Encoder (VAE) in the Stable Diffusion model and a 2D convolutional layer in a U-Network model (UNET) can be read out and stored in memory. UNET is a semantic segmentation model based on deep learning.

In one embodiment, the source code of the AIGC-based model is available and editable. In the present application, a neural network framework suitable for the source code can be selected, and all modules in the AIGC-based model are first loaded into the computer memory through the neural network framework, and then all 2D convolutional layers in the AIGC-based model are found by traversing the model modules, and the location information of these 2D convolutional layers in the memory is stored.

Exemplarily, the above-mentioned neural network framework may include PyTorch, Tensorflow, etc.

Among them, PyTorch is an open source machine learning library used for applicationssuch as natural language processing. PyTorch can be seen as an open source numerical computingextension tool (Numpy) with graphics processing unit (GPU) support, and can also be seen as a powerful deep neural networkwith automatic differentiation function. Tensorflow is a symbolic mathematics system based on data flow programming, which is widely used in the programming implementation of various machine learning algorithms. Tensorflow has a multi-level structure and can be deployed on various servers, personal computer terminals and web pages, and supports high-performance numerical computing of GPU and tensor processing unit (TPU).

702: change a padding mode in a horizontal direction of the 2D convolution layer to circular to obtain the AIGC image generation model.

According to position information of the 2D convolutional layers, the corresponding 2D convolutional layers are found, and the padding mode in the horizontal axis direction of these 2D convolutional layers is changed to circular, while the padding mode in the vertical axis direction remains unchanged, so that the action object of the convolutional layer in the obtained AIGC image generation model is converted from a flat 2D image to a cylindrical image by splicing together left and right sides of the flat 2D image, so that the vertical splicing seams of the target panoramic expansion view can be eliminated later.

703: obtaining a target panoramic expansion view output by the AIGC image generation model based on the initial panoramic expansion view.

After the initial panoramic expansion view is input, a completely new style of panoramic expansion view can be generated, that is, the target panoramic expansion view. The vertical splicing seams in the horizontal direction of the target panoramic expansion view have been completely eliminated, but the clustered splicing seams at the Antarctic Arctic regions still exist.

704: performing color matching on the initial panoramic expansion view and the target panoramic expansion view to obtain an intermediate panoramic expansion view that matches the color of the target panoramic expansion view.

When there is a significant difference in color between the target panoramic expansion view and the initial panoramic expansion view, if transparency fusion is directly performed, the color difference at the fusion place will be obvious. To solve this problem, the initial panoramic expansion view can be color matched with the target panoramic expansion view by histogram matching to obtain an intermediate panoramic expansion view with a similar color hue to the target panoramic expansion view.

705: obtaining an initial mask.

706: performing blur processing on the initial mask to obtain a target mask.

707: based on the target mask, using the target panoramic expansion view as a foreground image, and the Antarctic region and the Arctic region of the intermediate panoramic expansion view as background images to perform transparency fusion to obtain a fused panoramic expansion view.

The above exemplary embodiments have at least following beneficial effects:
(1) The padding method of the AIGC image generation model is changed to circular, which eliminates the vertical splicing seams of the target panoramic expansion view, improves image quality, and enhances the user's viewing experience.
(2) The initial mask is blurred to obtain a target mask so that the transition between the pixel values of the target mask becomes natural. In this way, the transition between the Antarctic region/the Arctic region and other regions in the obtained fused panoramic expansion view is also natural, thereby further improving the image quality and enhancing the user's viewing experience.
(3) Color matching is performed between the initial panoramic expansion view and the target panoramic expansion view to obtain an intermediate panoramic expansion view that matches the color of the target panoramic expansion view, thereby avoiding the problem of obvious color difference at the fusion place, improving image quality, and enhancing the user's viewing experience.
(4) Since the transparency values of the Antarctic region and the Arctic region in the initial mask are greater than or equal to the preset transparency value, and the size of the initial mask is consistent with the size of the target panoramic expansion view, after fusion, the Antarctic region and the Arctic region of the initial panoramic expansion view can be fused into the Antarctic region and the Arctic region of the fused panoramic expansion view. This achieves the purpose of eliminating the clustered splicing seams in the target panoramic expansion view, improving the image quality, and improving the user's viewing experience.

It is understood that, although the steps in the flowcharts involved in the above embodiments are displayed in sequence according to the indication of the arrows, these steps are not necessarily executed in sequence according to the order indicated by the arrows. Unless there is a clear description in this application, the execution of these steps is not strictly limited in order, and these steps can be executed in other orders. Moreover, at least a part of the steps in the flowcharts involved in the above embodiments may include multiple steps or multiple stages, and these steps or stages are not necessarily executed at the same time, but can be executed at different times, and the execution order of these steps or stages is not necessarily carried out in sequence, but can be executed in turn or alternately with other steps or at least a part of the steps or stages in other steps.

Based on the same inventive concept, an embodiment of the present application also provides a computer device for implementing the above-mentioned image generation method for eliminating splicing seams.

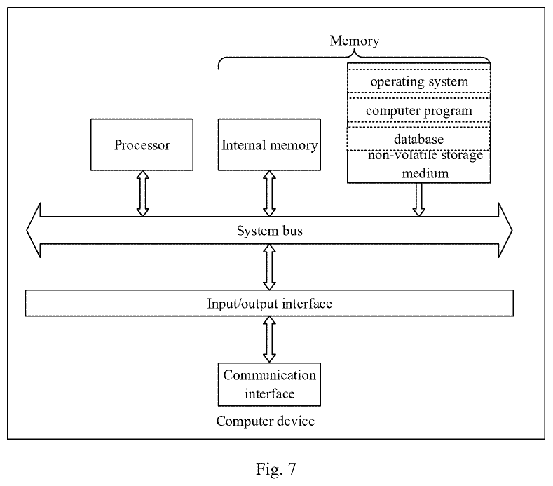

In one embodiment, a computer device is provided, which may be a server or a terminal, and its internal structure diagram may be shown in FIG. 7. The computer device includes a processor, a memory, an input/output interface (Input/Output, referred to as I/O) and a communication interface. The processor, the memory and the input/output interface are connected via a system bus, and the communication interface is connected to the system bus via the input/output interface. The processor of the computer device is used to provide computing and control capabilities. The memory of the computer device includes a non-volatile storage medium and an internal memory. The non-volatile storage medium stores an operating system, a computer program and a database. The internal memory provides an environment for the operation of the operating system and the computer program in the non-volatile storage medium. The database of the computer device is used to store image data. The input/output interface of the computer device is used to exchange information between the processor and an external device. The communication interface of the computer device is used to communicate with an external terminal via a network connection. When the computer program is executed by the processor, an image generation method for eliminating splicing seams is implemented.

Those skilled in the art will understand that the structure shown in FIG. 7 is merely a block diagram of a partial structure related to the solution of the present application, and does not constitute a limitation on the computer device to which the solution of the present application is applied. The specific computer device may include more or fewer components than shown in the figure, or combine certain components, or have a different arrangement of components.

In an exemplary embodiment, a computer device is provided, including a memory and a processor, wherein a computer program is stored in the memory, and the processor implements the following steps when executing the computer program: obtaining a panoramic expansion view generated by an AIGC image generation model based on input information, wherein a padding method of a convolutional layer in the AIGC image generation model is circular padding.

In one embodiment, the input information is an initial panoramic expansion view, the generated panoramic expansion view is a target panoramic expansion view, and the AIGC image generation model is used to transform the content and/or style of the initial panoramic expansion view to obtain the target panoramic expansion view.

In one embodiment, when horizontal splicing is required, the padding method of the convolution layer in the horizontal direction is circular padding.

In one embodiment, the method further includes: fusing the target area based on the initial panoramic expansion view and the target panoramic expansion view to obtain a fused panoramic expansion view, which includes:

color matching the initial panoramic expansion view and the target panoramic expansion view to obtain an intermediate panoramic expansion view, wherein the intermediate panoramic expansion view has a similar color hue to the target panoramic expansion view; and fusing the target area in the intermediate panoramic expansion view with the target panoramic expansion view to obtain a fused panoramic expansion view.

In one embodiment, the fusing the target area in the intermediate panoramic expansion view with the target panoramic expansion view to obtain a fused panoramic expansion view includes: taking the target panoramic expansion view as a foreground image and the target area in the intermediate panoramic expansion view as a background image to perform transparency fusion to obtain the fused panoramic expansion view.

In one embodiment, the target area is the Antarctic region and/or the Arctic region.

In one embodiment, the using the target panoramic expansion view as a foreground image, and the target area in the intermediate panoramic expansion view as a background image to perform transparency fusion to obtain the fused panoramic expansion view includes: obtaining an initial mask, wherein a size of the initial mask is consistent with the size of the target panoramic expansion view; based on the initial mask, using the target panoramic expansion view as a foreground image, and the target area in the intermediate panoramic expansion view as a background image to perform transparency fusion to obtain the fused panoramic expansion view.

In one embodiment, the method also includes: blackening a preset edge area of the initial mask, wherein the preset edge area corresponds to an area in the intermediate panoramic expansion view that will be fused into the target panoramic expansion view; blurring the blackened initial mask to obtain a target mask; based on the initial mask, taking the target panoramic expansion view as a foreground image and the target area in the intermediate panoramic expansion view as a background image to perform transparency fusion to obtain the fused panoramic expansion view, including: based on the target mask, taking the target panoramic expansion view as a foreground image and the target area in the intermediate panoramic expansion view as a background image to perform transparency fusion to obtain the fused panoramic expansion view.

In one embodiment, the Antarctic region is an image region composed of first pixels in the view, and the first pixels are pixels whose distance from the bottom edge in the height direction of the view is within a preset distance; the Arctic region is an image region composed of second pixels in the view, and the second pixels are pixels whose distance from the top edge in the height direction of the view is within a preset distance; the preset distance is a preset multiple of the height of the view, and the preset multiple may be less than ½.

In one embodiment, a computer readable storage medium is provided, on which a computer program is stored, and when the computer program is executed by a processor, the following steps are implemented:

obtaining a panoramic expansion view generated by an AIGC image generation model based on input information, wherein a padding method of a convolutional layer in the AIGC image generation model is circular padding.

In one of the embodiments, the input information is an initial panoramic expansion view, the generated panoramic expansion view is a target panoramic expansion view, and the AIGC image generation model is used to transform the content and/or style of the initial panoramic expansion view to obtain a target panoramic expansion view.

In one embodiment, when horizontal splicing is required, the padding method of the convolution layer in the horizontal direction is circular padding.

In one embodiment, the method further includes: fusing a target area based on the initial panoramic expansion view and the target panoramic expansion view to obtain a fused panoramic expansion view, including:
color matching the initial panoramic expansion view and the target panoramic expansion view to obtain an intermediate panoramic expansion view, wherein the intermediate panoramic expansion view has a similar color hue to the target panoramic expansion view; and fusing the target area in the intermediate panoramic expansion view with the target panoramic expansion view to obtain a fused panoramic expansion view.

In one embodiment, the fusing the target area in the intermediate panoramic expansion view with the target panoramic expansion view to obtain a fused panoramic expansion view includes: taking the target panoramic expansion view as a foreground image and the target area in the intermediate panoramic expansion view as a background image to perform transparency fusion to obtain the fused panoramic expansion view.

In one embodiment, the target area is the Antarctic region and/or the Arctic region.

In one embodiment, the using the target panoramic expansion view as a foreground image and the target area in the intermediate panoramic expansion view as a background image to perform transparency fusion to obtain the fused panoramic expansion view includes: obtaining an initial mask, wherein a size of the initial mask is consistent or same with the size of the target panoramic expansion view; based on the initial mask, using the target panoramic expansion view as a foreground image and the target area in the intermediate panoramic expansion view as a background image to perform transparency fusion to obtain the fused panoramic expansion view.

In one embodiment, the method also includes: blackening a preset edge area of the initial mask, wherein the preset edge area corresponds to an area in the intermediate panoramic expansion view that will be fused into the target panoramic expansion view; blurring the blackened initial mask to obtain a target mask; and based on the initial mask, taking the target panoramic expansion view as a foreground image and the target area in the intermediate panoramic expansion view as a background image to perform transparency fusion to obtain the fused panoramic expansion view, including: based on the target mask, taking the target panoramic expansion view as a foreground image and the target area in the intermediate panoramic expansion view as a background image to perform transparency fusion to obtain the fused panoramic expansion view.

In one embodiment, the Antarctic region is an image region composed of first pixels in the view, and the first pixels are pixels whose distance from the bottom edge in the height direction of the view is within a preset distance; the Arctic region is an image region composed of second pixels in the view, and the second pixels are pixels whose distance from the top edge in the height direction of the view is within a preset distance; the preset distance is a preset multiple of the height of the view, and the preset multiple is less than ½.

In one embodiment, a computer program product is provided, comprising a computer program, which, when executed by a processor, implements the following steps:
obtaining a panoramic expansion view generated by an AIGC image generation model based on input information, wherein a padding method of a convolutional layer in the AIGC image generation model is circular padding.

In one embodiment, the input information is an initial panoramic expansion view, the generated panoramic expansion view is a target panoramic expansion view, and the AIGC image generation model is used to transform the content and/or style of the initial panoramic expansion view to obtain a target panoramic expansion view.

In one embodiment, when horizontal splicing is required, the padding method of the convolution layer in the horizontal direction is circular padding.

In one embodiment, the method further includes: fusing the target area based on the initial panoramic expansion view and the target panoramic expansion view to obtain a fused panoramic expansion view, including:
color matching the initial panoramic expansion view and the target panoramic
expansion view to obtain an intermediate panoramic expansion view, wherein the intermediate panoramic expansion view has a similar color hue to the target panoramic expansion view; and
fusing the target area in the intermediate panoramic expansion view with the target panoramic expansion view to obtain a fused panoramic expansion view.

In one embodiment, the fusing the target area in the intermediate panoramic expansion view with the target panoramic expansion view to obtain a fused panoramic expansion view includes: taking the target panoramic expansion view as a foreground image and the target area in the intermediate panoramic expansion view as a background image to perform transparency fusion to obtain the fused panoramic expansion view.

In one embodiment, the target area is the Antarctic region and/or the Arctic region.

In one embodiment, the using the target panoramic expansion view as a foreground image and the target area in the intermediate panoramic expansion view as a background image to perform transparency fusion to obtain the fused panoramic expansion view includes: obtaining an initial mask, wherein a size of the initial mask is consistent or same with the size of the target panoramic expansion view; based on the initial mask, using the target panoramic expansion view as a foreground image, and the target area in the intermediate panoramic expansion view as a background image to perform transparency fusion to obtain the fused panoramic expansion view.

In one embodiment, the method also includes: blackening a preset edge area of the initial mask, wherein the preset edge area corresponds to an area in the intermediate panoramic expansion view that will be fused into the target panoramic expansion view; blurring the blackened initial mask to obtain a target mask; based on the initial mask, taking the target panoramic expansion view as a foreground image and the target area in the intermediate panoramic expansion view as a background image to perform transparency fusion to obtain the fused panoramic expansion view, including: based on the target mask, taking the target panoramic expansion view as a foreground image and the target area in the intermediate panoramic expansion view as a background image to perform transparency fusion to obtain the fused panoramic expansion view.

In one embodiment, the Antarctic region is an image region composed of first pixels in the view, and the first pixels are pixels whose distance from the bottom edge in the height direction of the view is within a preset distance; the Arctic region is an image region composed of second pixels in the view, and the second pixels are pixels whose distance from the top edge in the view height direction is within a preset distance; the preset distance is a preset multiple of the height of the view, and the preset multiple is less than ½.

A person of ordinary skill in the art can understand that all or part of the processes in the above-mentioned embodiment method can be completed by instructing the relevant hardware through a computer program, and the computer program can be stored in a non-volatile computer-readable storage medium. When the computer program is executed, it can include the processes of the embodiments of the above-mentioned methods. Among them, any reference to the memory, database or other medium used in the embodiments provided in the present application can include at least one of non-volatile and volatile memory. Non-volatile or non-transitory memory can include read-only memory (ROM), magnetic tape, floppy disk, flash memory, optical memory, high-density embedded non-volatile memory, resistive random access memory (ReRAM), magnetic random access memory (MRAM), ferroelectric random access memory (FRAM), phase change memory (PCM), graphene memory, etc. Volatile memory can include random access memory (RAM) or external cache memory, etc. As an illustration and not limitation, RAM can be in various forms, such as static random access memory (SRAM) or dynamic random access memory (DRAM). The database involved in each embodiment provided in this application may include at least one of a relational database and a non-relational database. Non-relational databases may include distributed databases based on blockchains, etc., but are not limited to this. The processor involved in each embodiment provided in this application may be a general-purpose processor, a central processing circuitry, a graphics processor, a digital signal processor, a programmable logic unit, a data processing logic unit based on quantum computing, etc., but are not limited to this.

The technical features of the above embodiments may be combined arbitrarily. To make the description concise, not all possible combinations of the technical features in the above embodiments are described. However, as long as there is no contradiction in the combination of these technical features, they should be considered to be within the scope of this specification.

The above-described embodiments only express several implementation methods of the present application, and the descriptions thereof are relatively specific and detailed, but they cannot be understood as limiting the scope of the present application. It should be pointed out that, for a person of ordinary skill in the art, several variations and improvements can be made without departing from the concept of the present application, and these all belong to the protection scope of the present application. Therefore, the protection scope of the present application shall be subject to the attached claims.

What is claimed is:

1. An image generation method for eliminating a splicing seam, comprising:
inputting input information into an AIGC image generation model; and
obtaining a panoramic expansion view generated by the AIGC image generation model based on the input information,
wherein a padding method of a convolutional layer in the AIGC image generation model comprises circular padding.

2. The image generation method according to claim 1, wherein the input information is an initial panoramic expansion view, the generated panoramic expansion view is a target panoramic expansion view, and the AIGC image generation model is configured to transform a content and/or style of the initial panoramic expansion view to obtain the target panoramic expansion view.

3. The image generation method according to claim 1, further comprising splicing the panoramic expansion view to obtain a seamless panoramic image.

4. The image generation method according to claim 3, wherein the splicing the panoramic expansion view comprises:
splicing the panoramic expansion view in a first direction,
wherein the padding method of the convolutional layer in the first direction is the circular padding.

5. The image generation method according to claim 2, further comprising:
fusing a target area based on the initial panoramic expansion view with the target panoramic expansion view to obtain a fused panoramic expansion view.

6. The image generation method according to claim 5, wherein the fusing the target area based on the initial panoramic expansion view with the target panoramic expansion view to obtain the fused panoramic expansion view comprises:
performing color matching on the initial panoramic expansion view and the target panoramic expansion view to obtain an intermediate panoramic expansion view, wherein the intermediate panoramic expansion view has a similar hue to the target panoramic expansion view; and
fusing the target area in the intermediate panoramic expansion view with the target panoramic expansion view to obtain the fused panoramic expansion view.

7. The image generation method according to claim 6, wherein the fusing the target area in the intermediate panoramic expansion view with the target panoramic expansion view to obtain the fused panoramic expansion view comprises:
using the target panoramic expansion view as a foreground image and the target area in the intermediate panoramic expansion view as a background image to perform transparency fusion to obtain the fused panoramic expansion view.

8. The image generation method according to claim 7, wherein the target area is Antarctic region and/or Arctic region.

9. The image generation method according to claim 7, wherein the using the target panoramic expansion view as the foreground image and the target area in the intermediate panoramic expansion view as the background image to perform the transparency fusion to obtain the fused panoramic expansion view comprises:
obtaining an initial mask, wherein a size of the initial mask is consistent with a size of the target panoramic expansion view; and
using the target panoramic expansion view as the foreground image and the target area in the intermediate panoramic expansion view as the background image to perform the transparency fusion based on the initial mask to obtain the fused panoramic expansion view.

10. The image generation method according to claim 9, further comprising:
blackening a preset edge region of the initial mask, wherein the preset edge region corresponds to a region in the intermediate panoramic expansion view to be fused into the target panoramic expansion view; and
blurring the initial mask after the blackening to obtain a target mask, and
wherein the using the target panoramic expansion view as the foreground image and the target area in the intermediate panoramic expansion view as the background image to perform the transparency fusion based on the initial mask to obtain the fused panoramic expansion view comprises:
using the target panoramic expansion view as the foreground image and the target area in the intermediate panoramic expansion view as the background image to perform the transparency fusion based on the target mask to obtain the fused panoramic expansion view.

11. The image generation method according to claim 8, wherein the Antarctic region is an image region composed of first pixels in the initial panoramic expansion view or the intermediate panoramic expansion view, and the first pixels are pixels whose distance from a bottom edge in a height direction of the initial panoramic expansion view or the intermediate panoramic expansion view is within a first preset distance;
the Arctic region is an image region composed of second pixels in the initial panoramic expansion view or the intermediate panoramic expansion view, and the second pixels are pixels whose distance from a top edge in a height direction of the initial panoramic expansion view or the intermediate panoramic expansion view is within a second preset distance; and
each of the first preset distance or the second present distance is a preset multiple of a height of the initial panoramic expansion view or the intermediate panoramic expansion view, and the preset multiple is less than ½.

12. A computer device, comprising at least one memory and at least one processor, wherein the at least one memory stores a computer program, and the at least one processor, when executing the computer program, is configured to:
input input information into an AIGC image generation model; and
obtain a panoramic expansion view generated by the AIGC image generation model based on the input information,
wherein a padding method of a convolutional layer in the AIGC image generation model comprises circular padding.

13. The computer device according to claim 12, wherein the input information is an initial panoramic expansion view, the generated panoramic expansion view is a target panoramic expansion view, and the AIGC image generation model is configured to transform a content and/or style of the initial panoramic expansion view to obtain the target panoramic expansion view.

14. The computer device according to claim 12, wherein the at least one processor is further configured to splice the panoramic expansion view to obtain a seamless panoramic image.

15. The computer device according to claim 14, wherein the splicing the panoramic expansion view comprises:
splicing the panoramic expansion view in a first direction,
wherein the padding method of the convolutional layer in the first direction is the circular padding.

16. The computer device according to claim 13, wherein the at least one processor is further configured to:
fuse a target area based on the initial panoramic expansion view with the target panoramic expansion view to obtain a fused panoramic expansion view.

17. The computer device according to claim 16, wherein the fusing the target area based on the initial panoramic expansion view with the target panoramic expansion view to obtain the fused panoramic expansion view comprises:
performing color matching on the initial panoramic expansion view and the target panoramic expansion view to obtain an intermediate panoramic expansion view, wherein the intermediate panoramic expansion view has a similar hue to the target panoramic expansion view; and
fusing the target area in the intermediate panoramic expansion view with the target panoramic expansion view to obtain the fused panoramic expansion view.

18. The computer device according to claim 17, wherein the fusing the target area in the intermediate panoramic expansion view with the target panoramic expansion view to obtain the fused panoramic expansion view comprises:
using the target panoramic expansion view as a foreground image and the target area in the intermediate panoramic expansion view as a background image to perform transparency fusion to obtain the fused panoramic expansion view.

19. The computer device according to claim 18, wherein the using the target panoramic expansion view as the foreground image and the target area in the intermediate panoramic expansion view as the background image to perform the transparency fusion to obtain the fused panoramic expansion view comprises:
obtaining an initial mask, wherein a size of the initial mask is consistent with a size of the target panoramic expansion view; and
using the target panoramic expansion view as the foreground image and the target area in the intermediate panoramic expansion view as the background image to perform the transparency fusion based on the initial mask to obtain the fused panoramic expansion view.

20. The computer device according to claim 19, wherein the at least one processor is further configured to:
blacken a preset edge region of the initial mask, wherein the preset edge region corresponds to a region in the intermediate panoramic expansion view to be fused into the target panoramic expansion view; and
blur the initial mask after the blackening to obtain a target mask, and
wherein the using the target panoramic expansion view as the foreground image and the target area in the intermediate panoramic expansion view as the background image to perform the transparency fusion based on the initial mask to obtain the fused panoramic expansion view comprises:
using the target panoramic expansion view as the foreground image and the target area in the intermediate panoramic expansion view as the background image to perform the transparency fusion based on the target mask to obtain the fused panoramic expansion view.
